(19) United States
(12) Patent Application Publication
(10) Pub. No.: US 2005/0162978 A1
(43) Pub. Date: Jul. 28, 2005

(54) Method of increasing avian safety in and around wind-powered electricity production facilities

(76) Inventor: Keith J. Lima, Fall River, MA (US)

Correspondence Address: Keith Lima, 56 Kings Way, Fall River, MA, 02720-8601, US

(21) Appl. No.: 10/764,119

(22) Filed: Jan. 26, 2004

(51) Int. Cl. H04B 1/02

(52) U.S. Cl. 367/139

(57) ABSTRACT

A method of preventing bird deaths in wind-powered power plants. The method involves, forcing the birds away from the windmills by means of a strong ultrasonic transducer. Once this is accomplished the perimeter is sealed by motion detectors. If a bird is detected by the detectors, the ultrasonic transducer is activated thereby forcing the bird away from the protected area.

### CROSS-REFERENCE TO RELATED PATENTS

Not Applicable.

### BACKGROUND--FIELD OF METHOD

This method relates to wild life deaths, specifically avian deaths, in and around wind powered electrical production facilities, which is usually caused by spinning drive fans on the windmill generators.

### BACKGROUND--DESCRIPTION OF PRIOR ART

Wind powered electricity production facilities produce electricity by means of a windmill or fan blade(s) being mechanically connected to electrical generators. When wind turns the fan, a drive shaft connected to the fan and generator, turns the generator, thereby producing electricity.

However, these turning blades can be a significant danger to local bird populations because, for various reasons, birds of many different kinds, often get hit by moving fan blades while in flight. Usually the birds are struck with such force that the bird dies and is usually a result of blunt force trauma.

The problems caused by the death of so many birds stretch far beyond a reduction in the local bird population. Among the types of birds which are being killed in this manner are many types of endangered hawks and eagles. As a result, many environmentalist groups and agencies are beginning to put pressure on many wind powered power plants and are calling for stricter environmental laws and even the partial or total relocation or shut down of some or all of the facilities.

This is putting a great amount of strain on an industry that provides electricity for millions of americans in the untied states, especially California. Large amounts of revenue has to be spent on legal protection from environmentalist groups and locals who are complaining about the reduction in the avian population.

### SUMMARY

In accordance with the problems and difficulties posed to all parties involved in these matters including the bird's, a solution is therefore needed.

### OBJECTS AND ADVANTAGES

Accordingly, besides the obvious problems listed above, several objects and advantages of the present method are:
(a) To provide for the safety of the birds which usually fly in and around the power plant grounds and air space.
(b) To provide for an increased ability in environmental agencies, groups, local and national legislatures to provide for the safety of the local and national bird populations.
(c) To provide for a higher revenue and increased efficiency of the power plants by decreasing the need for clean up, maintenance, and legal protection.

Still further objects and advantages will become apparent from a consideration of the ensuing description and drawings.

### DRAWING FIGURE AND REFERENCE NUMERALS

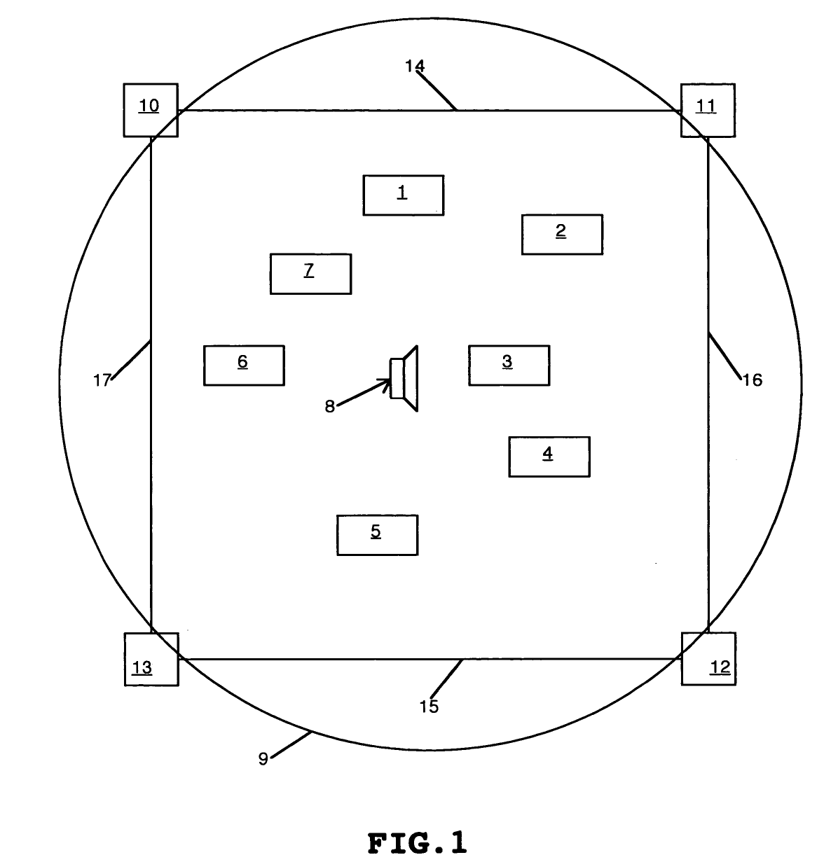

The drawing, FIG. 1, shows how the method of increasing bird safety around wind based power plants would work. Reference numerals for which are the following:

| | |
|---|---|
| 1 wind mill generator | 2 wind mill generator |
| 3 wind mill generator | 4 wind mill generator |
| 5 wind mill generator | 6 wind mill generator |
| 7 wind mill generator | 8 ultrasonic transducer |
| 9 effective range of ultrasound | 10 active motion detector |
| 11 active motion detector | 12 active motion detector |
| 13 active motion detector | 14 transmission path |
| 15 transmission path | 16 transmission path |
| 17 transmission path | |

### DESCRIPTION-FIG. 1-PREFERRED EMBODIMENT

A preferred embodiment of the method is illustrated in FIG. 1. None of the objects in the figure are drawn to scale because real world terrain and windmill sizes vary. Reference numerals 1 through 7 represent various windmills that would be found on the grounds of a wind power facility. Numeral 8 is an ultrasonic transducer placed in the center of the protected area. Numeral 9 represents the affective range at which the ultrasound will create such an annoyance to the birds that most of the birds will not fly into that radius.

Numerals 10 through 13 represent active motion detectors or reflectors which transmit or reflect electromagnetic waves, probably in the radar or microwave region, and detect an abnormal reflection, or cessation of the transmitted energy, in the transmission path, numerals 14 through 17. When an interruption is detected in the signal, the device will then activate the ultrasonic transducer 8 thereby causing the birds to leave the now uncomfortable environment where the windmills are located. The system can be started with birds already in the area to be protected. The transducer can be activated, and once the birds have left, can then be deactivated and the detection system turned on.

The reason for not having the transducer on all the time is that studies have shown that wild life eventually becomes accustomed to loud ultrasonic transmissions. Furthermore, the motion detectors can transmit any form of energy besides microwave or radar. lasers, as well infrared can be used, and the possibility of using directed ultrasound as a means of detection is not discounted.

### OPERATION--FIG 1

The manner in which the method works is simple. The detectors and reflectors 10 through 13 are located at or close to the maximum affective range of the ultrasonic transducer 9. The energy from the detectors can be retransmitted and received by pairs of detectors or one detector can be paired with many reflectors to reflect the energy around the affective area. When The system is started, the transducer 8 is activated, clearing out all the birds in the area. Once this is accomplished the detectors/reflectors will sound the alarm any time a bird crosses the transmission path 14 through 17.

### CONCLUSION, RAMIFICATIONS, AND SCOPE

Accordingly, the reader will see that the method accomplishes the following:
it provides for the safety of the birds which usually fly in and around the power plant grounds and air space.
it provides for an increased ability in environmental agencies, groups, local and national legislatures to provide for the safety of the local and national bird populations.
it provides for a higher revenue and increased efficiency of the power plants by decreasing the need for clean up, maintenance, and legal protection.

Although the description above contains many specifications, these should not be construed as limiting the scope of the method but are merely providing illustrations of one of the presently preferred embodiments of this method. For example, a power production facility can have more or less than 7 windmills and they will most likely be arranged in a different order. There can be more or less detectors and reflectors, and there may be one transmission path reflected around the area or as many as the figure illustrates, if not more etc. Thus the scope of the method should be determined by the appended claims and there legal equivalents, rather than by the examples given.

1. A method in which a device or devices can be placed on, and/or over, and/or around the grounds of a facility which contains one, several, or many windmills which may or may not be used to produce electricity and having a device or devices that will help prevent and or illuminate bird fatalities on or over the grounds of said facilities by preventing and/or impeding the birds from flying near and/or into the fan blades or being struck by said fan blades of said windmills by creating ultrasonic or sonic waves to prevent or impede said bird or birds from entering and/or being near the windmills and said facilities when the birds pass between a transmitter and a receiver which transmits energy, which may or may not be limited to electromagnetic energy.

2. The method may be comprised of one transmitter and one receiver in which said transmitted energy can be bounced off of reflectors to detect birds who cross a given perimeter.

3. The method may also be comprised of several transmitters which may be combined to detect birds which are crossing said perimeter.

4. The method also contains an ultrasonic and/or sonic transmitter or transmitters.

5. The said sonic and/or ultrasonic waves can be activated with out said bird or birds from passing between said receivers and transmitters.
